(19) United States
(12) Patent Application Publication
(10) Pub. No.: US 2021/0409523 A1
(43) Pub. Date: Dec. 30, 2021

(54) NETWORK APPARATUS

(71) Applicant: XIAMEN LEEDARSON LIGHTING CO.,LTD, Xiamen (CN)

(72) Inventors: Quanxi Liu, Xiamen (CN); Runfu Zhang, Xiamen (CN)

(21) Appl. No.: 17/364,725

(22) Filed: Jun. 30, 2021

(30) Foreign Application Priority Data
Jun. 30, 2020 (CN) 202010615159.X

(51) Int. Cl. H04L 29/06

(52) U.S. Cl. CPC H04L 69/14; H04L 69/08

(57) ABSTRACT

A network apparatus includes a first network interface, a second network interface and a processor. The first network interface is used for connecting to an network service host via a first network protocol to connect to the Internet. The second network interface for connecting to another network apparatus via a second network protocol. The first network interface is different from the second network interface. The processor is coupled to the first network interface and the second network interface for determining one from at least a first network mode and a second network mode. In the first network mode, the first network is activated for connecting to the Internet via the network service host and provides a network service for said another network apparatus to connect to the Internet.

### FIELD

The present invention is related to a network apparatus, and more particularly related to a network apparatus with flexible setting.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

IoT (Internet of Things) devices are more and more used in various areas, including light devices. However, it is always a critical problem if the setting is difficult or complicated.

Unless a convenient and flexible way of setting, e.g. network basic information, it is difficult to push the products around the market.

Therefore, it is beneficial to design a flexible network device that is convenient to use and easy to set. IoT (Internet of Things) devices are more and more used in various areas, including light devices. However, it is always a critical problem if the setting is difficult or complicated.

Unless a convenient and flexible way of setting, e.g. network basic information, it is difficult to push the products around the market.

Therefore, it is beneficial to design a flexible network device that is convenient to use and easy to set. IoT (Internet of Things) devices are more and more used in various areas, including light devices. However, it is always a critical problem if the setting is difficult or complicated.

Unless a convenient and flexible way of setting, e.g. network basic information, it is difficult to push the products around the market.

Therefore, it is beneficial to design a flexible network device that is convenient to use and easy to set. IoT (Internet of Things) devices are more and more used in various areas, including light devices. However, it is always a critical problem if the setting is difficult or complicated.

Unless a convenient and flexible way of setting, e.g. network basic information, it is difficult to push the products around the market.

Therefore, it is beneficial to design a flexible network device that is convenient to use and easy to set.

### SUMMARY

In some embodiments, a network apparatus includes a first network interface, a second network interface and a processor.

The first network interface is used for connecting to an network service host via a first network protocol to connect to the Internet. For example, the first network interface is a Wi-Fi communication transceiver for connecting to a Wi-Fi hotspot to connect to the Internet.

The second network interface for connecting to another network apparatus via a second network protocol. For example, the second network interface may be Bluetooth, ZigBee, or any short range wireless networks.

The first network interface is different from the second network interface.

The processor is coupled to the first network interface and the second network interface for determining one from at least a first network mode and a second network mode.

In the first network mode, the first network is activated for connecting to the Internet via the network service host and provides a network service for said another network apparatus to connect to the Internet.

In the second network mode, the processor seeks the network service from said another network apparatus to connect to the Internet.

In some embodiments, the processor sends a broadcast message via the second network protocol to find available said another network apparatus.

In some embodiments, the processor also finds all available simple network devices.

The simple network device only has the second network interface and does not have the first network interface.

The processor controls the simple network devices.

In some embodiments, if the processor determines that said another network apparatus capable of providing the network service connecting to the Internet, the processor determines switching from the first network mode to the second network mode based on a predetermined rule.

In some embodiments, the predetermined rule includes when the processor determines the network service provided by said another network apparatus is higher than the first network interface.

In some embodiments, the predetermined rule includes when the processor determines the network service provided by said another network apparatus has lower monetary cost than the first network interface.

In some embodiments, the predetermined rule includes that the processor switches from the second network mode to the first network mode when a scene setting is satisfied.

In some embodiments, the predetermined rule includes that the processor detects a signal quality of the first network interface and compares the signal quality with another signal quality of said another network apparatus.

In some embodiments, the processor determines a device type of said another network apparatus and determines choosing the first network mode or the second network mode.

In some embodiments, the processor selects a third network mode.

In the third network mode, a portion of network traffic is carried via the first network interface and another portion of network traffic is carried via the network service provided by said another network apparatus.

In some embodiments, the processor translates an external command to a corresponding control message to said another network apparatus to control said another network apparatus.

In some embodiments, there are multiple said another network apparatuses.

The processor generates different control messages respectively to different said another network apparatuses according to one external command.

In some embodiments, the network apparatus may also include a light source.

The processor controls the light source according to an external command received from an external device.

In some embodiments, said another network apparatus also has another light source, and the processor controls the light source and said another light source based on the external command.

In some embodiments, the processor receives an external command to switch between the first network mode and the second network mode.

In some embodiments, the processor provides a user interface for a user to configure password data for the first network interface to connect to the Internet.

In some embodiments, the password data are transmitted to said another network apparatus for said another network apparatus to connect to the network service host directly.

In some embodiments, said another network apparatus has another processor.

The processor dispatches a portion of processing task to said another processor.

In some embodiments, the process disables the first network interface after receiving a setting data via the first network interface.

In some embodiments, the network apparatus may also include a manual hardware switch for a user to manually operate the manual hardware switch to disable the first network interface.

### BRIEF DESCRIPTION OF DRAWINGS

FIG. 1 illustrates a network diagram showing relation among

FIG. 2 illustrates a scenario diagram that shows devices disposed in different areas.

FIG. 3A illustrates an example of network apparatuses arrangement.

FIG. 3B illustrates an example of network apparatus arrangement.

FIG. 4A illustrates a configuration example of multiple network apparatuses.

FIG. 4B illustrates an usage configuration example.

FIG. 4C illustrates an usage configuration example.

FIG. 5 illustrates a configuration example of multiple network devices.

FIG. 6 illustrates an architecture of a network apparatus.

FIG. 7 illustrates a working system of a network apparatus.

### DETAILED DESCRIPTION

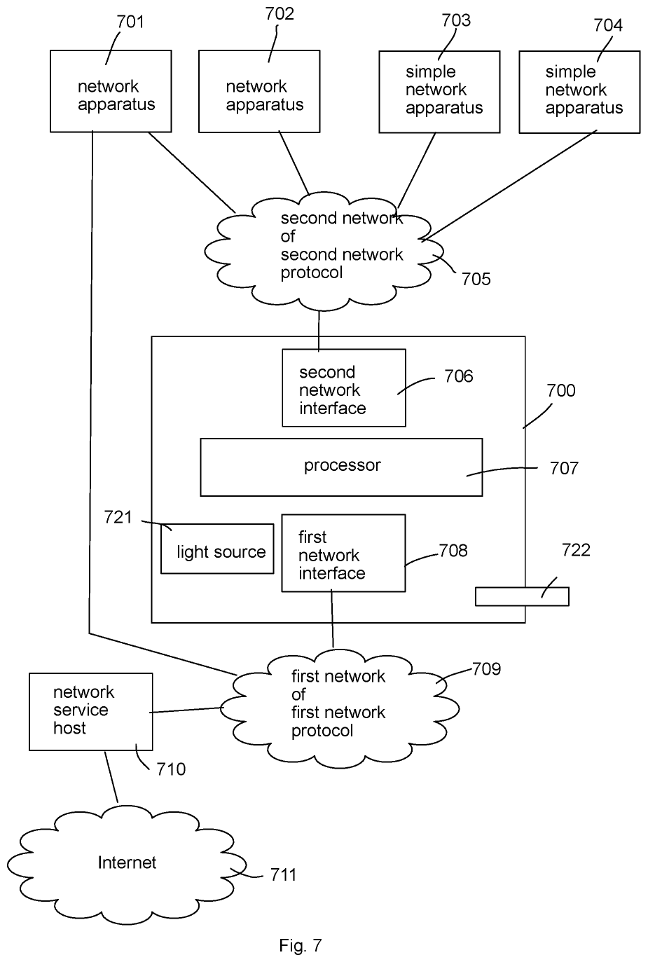

In FIG. 7, a network apparatus 700 includes a first network interface 708, a second network interface 709 and a processor 707.

The first network interface 708 is used for connecting to an network service host 710 via a first network 709 based on a first network protocol to connect to the Internet 711. For example, the first network interface is a Wi-Fi communication transceiver for connecting to a Wi-Fi hotspot to connect to the Internet 711.

A network is built upon a set of rules of message format and processing flow. The first network protocol defines a set of rules of message format and processing flow for building the first network. The first network contains multiple network devices to be connected.

The second network interface for connecting to another network apparatus 701 via a second network 705 of a second network protocol. For example, the second network interface may be Bluetooth, ZigBee, or any short range wireless networks.

The first network interface is different from the second network interface.

The processor 707 is coupled to the first network interface 708 and the second network interface 706 for determining one from at least a first network mode and a second network mode.

The processor 707, the first network interface 708 and the second network interface 706 may be implemented with circuits, microprocessors with program codes or other electronic devices, e.g. a combination of multiple electronic components.

In the first network mode, the first network interface 708 is activated for connecting to the Internet via the network service host 710 and provides a network service for said another network apparatus 701 to connect to the Internet 711.

For example, the processor may control data exchange between the network apparatus 700 and said another network apparatus 701 so as to allow said another network apparatus 701 to connect to the Internet 711.

For example, the network apparatus 700 may perform as an intermediate device responsible to send and to receive data to the Internet 711 based on received data from said another network apparatus 701.

There may be multiple said another network apparatuses 701, 702 connected to the network apparatus 700 via the second network 705.

In the second network mode, the processor seeks the network service from said another network apparatus to connect to the Internet.

This shows another connecting path. In such mode, the network apparatus 700 connects to the Internet 711 via said another network apparatus 701. In such case, said another network apparatus 701 is connected to the network service host 710 so as to be connected to the Internet. The Internet is the giant global network used widely around the world.

The network apparatus 700 and said another network apparatus 701 may be the same completely. For example, the network apparatuses 700 and said another network apparatus 701 are two light devices with the same first network interface and the second network interface. In addition, they both have light sources. In other examples, the network apparatus 700 may be a light device with the first network interface and the second network interface. Said another network apparatus may be a speaker with the first network apparatus and the second network interface.

The speaker may be used for routing network traffic to the Internet, including helping the light device to do so. Under certain setting, e.g. manual setting or automatic setting, the light device may route the traffic of the speaker to the Internet on the opposite direction.

In some embodiments, the processor sends a broadcast message via the second network protocol to find available said another network apparatus.

In some embodiments, the processor also finds all available simple network devices 703, 704.

The simple network device 703 or 704 only has the second network interface and does not have the first network interface.

The processor controls the simple network devices. In other words, only a light device is capable of communicating with the network service host 701 to connect to the Internet 711. The simple network devices 703, 704 are controlled by the light device but are not capable of connecting directly to the Internet 711.

In some embodiments, if the processor determines that said another network apparatus capable of providing the network service connecting to the Internet, the processor determines switching from the first network mode to the second network mode based on a predetermined rule.

For example, the network apparatus uses the second network 705 to connect to said another network apparatus 701 to be indirectly connecting to the Internet 711 when some condition in a predetermined rule is satisfied.

In some embodiments, the predetermined rule includes when the processor determines the network service provided by said another network apparatus is higher than the first network interface. Specifically, the network service via said another network apparatus has larger bandwidth or flow speed.

In some embodiments, the predetermined rule includes when the processor determines the network service provided by said another network apparatus has lower monetary cost than the first network interface. Specifically, the data collected by the processor 707 determines that it has lower cost to connect to the Internet via said another network apparatus.

In some embodiments, the predetermined rule includes that the processor switches from the second network mode to the first network mode when a scene setting is satisfied. For example, there is a first scene in which the user uses his mobile phone as a Wi-Fi hot spot and there is a second scene in which the user uses another hot spot. In different cases, the network apparatus determines to connect to the Internet 11 directly or indirectly.

In some embodiments, the predetermined rule includes that the processor detects a signal quality of the first network interface and compares the signal quality with another signal quality of said another network apparatus. Sometimes, the signal quality may be changed dynamically. Sometimes, users are not aware of which configuration is best for quality transmission. In such case, the network apparatuses automatically calculate and find an optimal solution to do the network work.

In some embodiments, the processor determines a device type of said another network apparatus and determines choosing the first network mode or the second network mode. For example, when the processor finds a device is a hot spot device, instead of a speaker, the processor determines to connect to the Internet 711 indirectly via said another network apparatus 701.

In some embodiments, the processor selects a third network mode. Specifically, the processor 707 controls switching of the first network mode and the second network mode.

In the third network mode, a portion of network traffic is carried via the first network interface and another portion of network traffic is carried via the network service provided by said another network apparatus.

In some embodiments, the processor translates an external command to a corresponding control message to said another network apparatus to control said another network apparatus. For example, the external command may be “turn on the lights”. The network apparatus 700 receives this command and controls the simple network devices 703, 704 to turn on their light sources with different light intensities previously stored in the processor 707 with two different control signals.

In some embodiments, there are multiple said another network apparatuses.

The processor generates different control messages respectively to different said another network apparatuses according to one external command.

In some embodiments, the network apparatus may also include a light source 721.

The processor controls the light source according to an external command received from an external device.

In some embodiments, said another network apparatus also has another light source, and the processor controls the light source and said another light source based on the external command.

In some embodiments, the processor receives an external command to switch between the first network mode and the second network mode.

In some embodiments, the processor provides a user interface for a user to configure password data for the first network interface to connect to the Internet. For example, the network service host 710 may need ID/password to be connected to use the Internet service. The ID/password data are transferred to said another network apparatus 701 via the network apparatus 700.

In some embodiments, the password data are transmitted to said another network apparatus for said anther network apparatus to connect to the network service host directly.

In some embodiments, said another network apparatus has another processor.

The processor dispatches a portion of processing task to said another processor. Specifically, the computation may be performed together by two network apparatuses.

In some embodiments, the process disables the first network interface after receiving a setting data via the first network interface. Sometimes, users may have security concern. In such case, the first network interface may be used temporarily for setting and then locked unless being unlocked again.

In some embodiments, the network apparatus may also include a manual hardware switch 722 for a user to manually operate the manual hardware switch to disable the first network interface. This also helps increase security because IoT is not secure enough to defend hacking attacks. Some users may want to disable network function to ensure security.

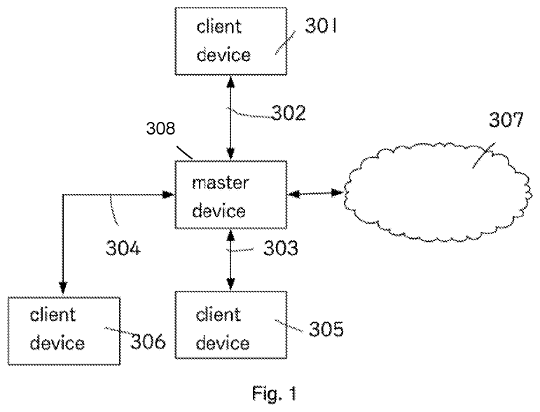

Please refer to FIG. 1. In FIG. 1, a master device 308 has the first network interface and the second network interface. The master device 308 helps route traffic of the client devices 301, 305, 306 from the second networks 303, 304 like Bluetooth to the destination network 307 like Internet.

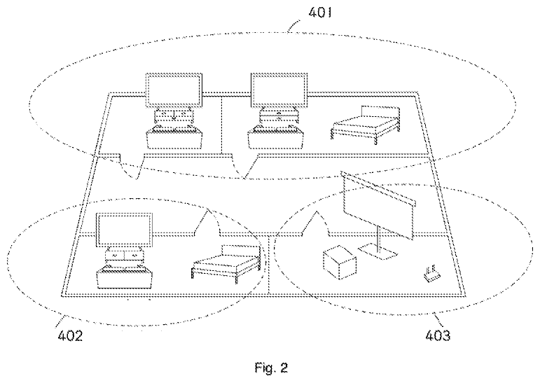

Please refer to FIG. 2. In FIG. 2, multiple network devices are located in different areas 401, 402, 403. Corresponding scenes may be set when these network devices are located in different areas. For example, a network apparatus with a light source may be used as a major Wi-Fi hot spot when the network apparatus is installed in a bed room. The same network apparatus may be set as a client device, e.g. to connect to the Internet indirectly from another network apparatus, when installed in a living room.

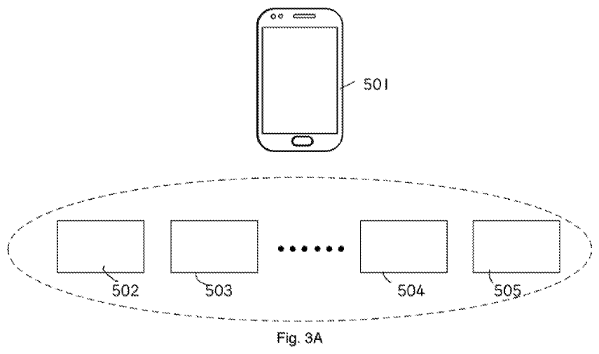

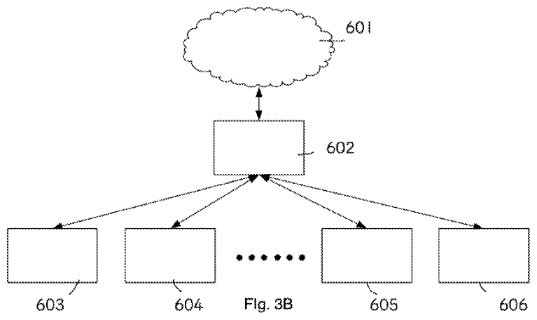

In FIG. 3A, a mobile phone 501 with installed app sends an external command to one of the network apparatuses 502 to assign one network apparatus 502 to be the Wi-Fi hot spot while other network apparatuses 503, 504, 505 to connect to the Internet via the network apparatus 502.

In FIG. 3B, a network apparatus 602 is selected as the master device to help other client devices 603, 604, 605, 606 to connect to the Internet 601. As mentioned above, the selection of the master device may be dynamically changed. For example, the network apparatus 603 may be changed as the master device while other network apparatuses are connected to the Internet 601 via the network apparatus 603.

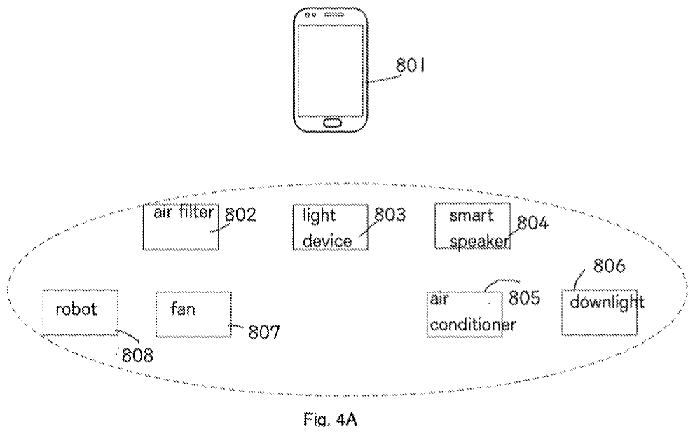

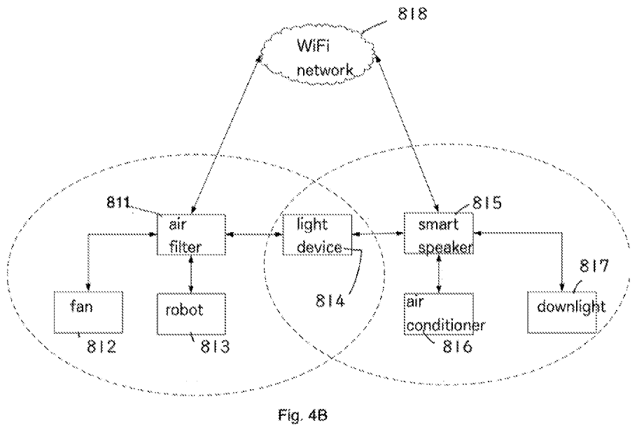

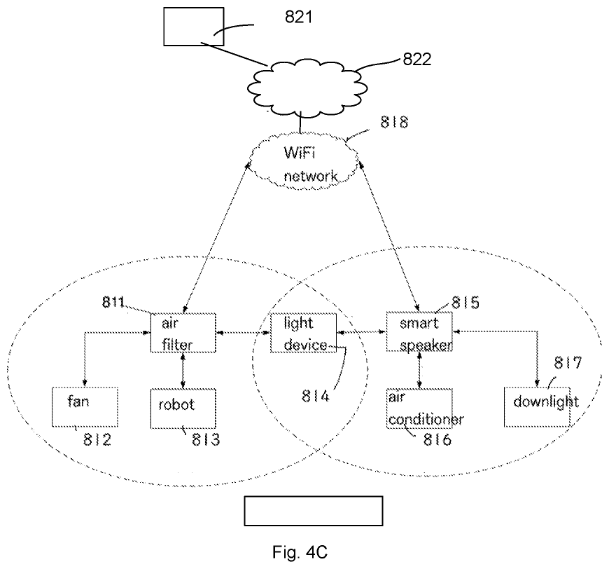

In FIG. 4A, different network apparatuses respectively have different function modules to form different devices. In this example, the mobile phone 801 controls all other network apparatuses, the light device 803, the air filter 802, the smart speaker 804, the downlight 806, the air conditioner 805, the fan 807 and the robot 808 and also change the settings as master devices or client devices as mentioned above.

In FIG. 4B, a configuration example is provided as an example of usage of the method mentioned above.

The air filter 811 helps transfer traffic of the fan 812 and the robot 813 to the Wi-Fi network 818 in a bed room.

The light device 814 helps transfers traffic between the air filter 811 and the smart speaker 815.

The smart speaker 815 helps transfers traffic of the air conditioner 816 and the downlight 817 to the Wi-Fi network 818 in a living room.

In FIG. 4C, a mobile phone 821 not located in the house sends an external command via the Internet to control the air filter 811 and other devices.

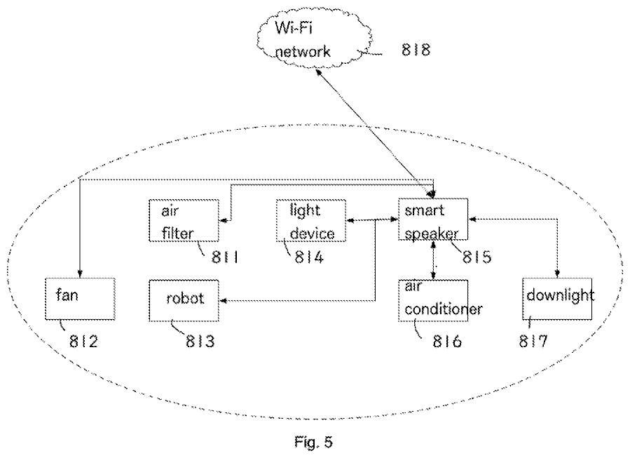

In FIG. 5, the network apparatuses in FIG. 4B are configured to change their connection relation. The same reference numerals refer to the same components.

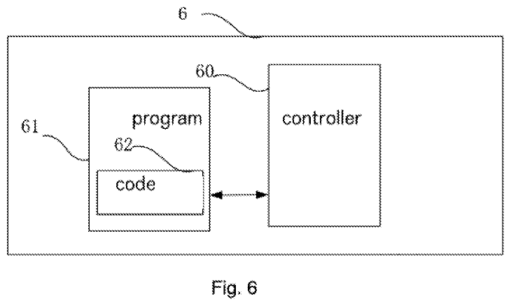

In FIG. 6, a system architecture example of a network apparatus 6 is illustrated. In FIG. 6, the controller executing a portion of code 62 from a program 61 stored in a memory device. As mentioned above, a portion of the function of the processor may be executed by a controller that is able to execute program codes while some other functions are implemented by hardware circuit like antenna and transceivers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A network apparatus, comprising:
a first network interface for connecting to an network service host via a first network protocol to connect to the Internet;
a second network interface for connecting to another network apparatus via a second network protocol, wherein the first network interface is different from the second network interface; and
a processor coupled to the first network interface and the second network interface for determining one from at least a first network mode and a second network mode, wherein in the first network mode, the first network is activated for connecting to the Internet via the network service host and provides a network service for said another network apparatus to connect to the Internet, wherein in the second network mode, the processor seeks the network service from said another network apparatus to connect to the Internet.

2. The network apparatus of claim 1, wherein the processor sends a broadcast message via the second network protocol to find available said another network apparatus.

3. The network apparatus of claim 1, wherein the processor also finds all available simple network devices, wherein the simple network device only has the second network interface and does not have the first network interface, wherein the processor controls the simple network devices.

4. The network apparatus of claim 1, wherein if the processor determines that said another network apparatus capable of providing the network service connecting to the Internet, the processor determines switching from the first network mode to the second network mode based on a predetermined rule.

5. The network apparatus of claim 4, wherein the predetermined rule comprises when the processor determines the network service provided by said another network apparatus is higher than the first network interface.

6. The network apparatus of claim 4, wherein the predetermined rule comprises when the processor determines the network service provided by said another network apparatus has lower monetary cost than the first network interface.

7. The network apparatus of claim 4, wherein the predetermined rule comprises that the processor switches from the second network mode to the first network mode when a scene setting is satisfied.

8. The network apparatus of claim 4, wherein the predetermined rule comprises that the processor detects a signal quality of the first network interface and compares the signal quality with another signal quality of said another network apparatus.

9. The network apparatus of claim 4, wherein the processor determines a device type of said another network apparatus and determines choosing the first network mode or the second network mode.

10. The network apparatus of claim 1, wherein the processor selects a third network mode, wherein in the third network mode, a portion of network traffic is carried via the first network interface and another portion of network traffic is carried via the network service provided by said another network apparatus.

11. The network apparatus of claim 1, wherein the processor translates an external command to a corresponding control message to said another network apparatus to control said another network apparatus.

12. The network apparatus of claim 11, wherein there are multiple said another network apparatuses, the processor generates different control messages respectively to different said another network apparatuses according to one external command.

13. The network apparatus of claim 1, further comprising a light source, wherein the processor controls the light source according to an external command received from an external device.

14. The network apparatus of claim 13, wherein said another network apparatus also has another light source, and the processor controls the light source and said another light source based on the external command.

15. The network apparatus of claim 1, wherein the processor receives an external command to switch between the first network mode and the second network mode.

16. The network apparatus of claim 1, wherein the processor provides a user interface for a user to configure password data for the first network interface to connect to the Internet.

17. The network apparatus of claim 16, wherein the password data are transmitted to said another network apparatus for said another network apparatus to connect to the network service host directly.

18. The network apparatus of claim 1, wherein said another network apparatus has another processor, the processor dispatches a portion of processing task to said another processor.

19. The network apparatus of claim 1, wherein the process disables the first network interface after receiving a setting data via the first network interface.

20. The network apparatus of claim 1, further comprising a manual hardware switch for a user to manually operate the manual hardware switch to disable the first network interface.
